(19) United States
(12) Patent Application Publication
(10) Pub. No.: US 2021/0248982 A1
(43) Pub. Date: Aug. 12, 2021

(54) FLEXIBLE STAND FOR STRINGED MUSICAL INSTRUMENTS

(71) Applicants: MURAD MAHMOUD, Kobenhavn O (DK); MARTIN BEUCHERT, Vejle ost (DK)

(72) Inventors: Murad Mahmoud, Copenhagen (DK); Martin Beuchert, Vejle (DK)

(21) Appl. No.: 17/170,039

(22) Filed: Feb. 8, 2021

Related U.S. Application Data
(60) Provisional application No. 62/971,235, filed on Feb. 7, 2020.

(51) Int. Cl. G10G 5/00

(52) U.S. Cl. CPC G10G 5/00; G10D 1/08

(57) ABSTRACT

An apparatus for parking stringed musical instruments in an upright position is disclosed. The apparatus comprises of a flexible body wherein the front side of the flexible body has an adhesive that allows the apparatus to be removably attached to the lower end face of the stringed musical instrument. Furthermore, a combination of three/four legs are provided on the rear side of the flexible body. The combined support provided by the legs allow the stringed musical instrument attached on the apparatus to be parked in an upright position on the ground.

### CROSS-REFERENCE TO RELATED APPLICATIONS

This application claims the benefit of U.S. Provisional Patent Application Ser. No. 62/971,235, entitled “Apparatus for supporting musical instruments”, filed on Feb. 7, 2020, which is incorporated herein in its entirety.

### TECHNICAL FIELD

The present disclosure is related to the field of musical instruments. More particularly, the present disclosure is related to accessories for conveniently parking/storing stringed musical instruments.

### BACKGROUND

Stringed musical instruments such as guitars, violins, cellos, ukuleles, and the like are widely used musical instruments across the world. Storing and displaying such instruments are generally cumbersome due to their sensitive nature and build. While several techniques are proposed and used for parking them when not in use and/or displaying them at stores, each of these techniques come with a set of disadvantages.

Generic stands and supports used for parking such instruments typically have to use fastenings mechanisms such as screws, nuts, bolts, strings, and the like. Such accessories need to be mechanically fixed to the instrument using a particular connecting/disconnecting method every time the instrument is to be used. Moreover, many such accessories have parts that are to be permanently fixed onto the musical instrument thereby affecting the physical structure of the musical instrument. Furthermore, the amount of time and effort required to attach and detach such accessories adds to the worry of users thereby dissuading them from picking up the instruments very often.

According to behavioural psychology, constant availability/access to any study material increases the chances of a student using that material exponentially. In this example, for a musician and for students who are trying to use/learn a musical instrument, making the instrument constantly available at their sight exponentially increases the chances of them playing the instrument more often than normal. Hence, providing accessories such as “easy to use stands” for musical instruments makes it convenient for users to access them regularly.

U.S. Pat. No. 8,536,432B1 discloses a rest for guitar-like instruments which is internally configured to receive the bottom of a guitar-like instrument and to allow the instrument to lean against another object. Preferably, a groove is provided in the bottom of the rest to allow the rest to fit over the handle of an amplifier. Also, the cavity is preferably shaped such that the back of the top of the guitar-like instrument leans on a wall or other supporting structure.

US20180137841A1 discloses a stand for a stringed instrument that may be adapted to be placed in either a playing position for playing music or a parking position in which the instrument is placed on the ground with the head uppermost and the body lowermost. The stand has a foot member for supporting the instrument in the parking position, an upper connector placed on the lower end face of the instrument body, and a lower connector arranged on the foot member whereby the connectors are arranged for permanent or temporary interconnection. The stand is placed beneath the lower end face of the body of the stringed instrument and within the borders of the end face for providing a nice appearance of the parked stringed instrument.

While the cited prior arts try to address the problem of easily attaching and removing stands onto stringed instruments, the disadvantages with respect to their designs are a concern. While some prior arts require accessories to be fixed permanently for attachment/detachment of the stand, others have dimensions and form factors that make them inconvenient for easy storage and retrieval.

The present disclosure addresses the abovementioned technical problems to provide a solution for users of stringed musical instruments to easily and securely park their instruments and access them conveniently when required with least effort.

### SUMMARY

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments described herein discloses an apparatus for securely parking a stringed musical instrument in an upright position. The apparatus comprises of a body, preferably made of a flexible material such as thermoplastic polyurethane (TPU) that may be easily attached/detached onto the instrument. The front side of the body may be provided with an adhesive that allows easy attachment/detachment of the apparatus with the musical instrument. The front side of the body of the apparatus that comprises the adhesive may be attached to the lower end face of the instrument. The lower end face of the instrument may generally have a curved structure with varying level of curvature depending upon the type and size of the instrument.

The flexible nature of the apparatus allows it to adapt with instruments of different shapes and sizes. The rear side of the apparatus may have three or four legs, arranged in a triangular pattern (for three legs) or a rectangular pattern (for four legs). The three/four-legged configuration of the apparatus allows the instrument to stay in an upright position when placed on the ground. The centre-of-gravity of the musical instrument may pass through the central portion of the apparatus thereby providing adequate support to the instrument when parked upright on the apparatus.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is a perspective view depicting the front side of the apparatus for parking stringed musical instruments with a three-legged arrangement according to the embodiments of the present disclosure;

FIG. 2 is a perspective view depicting the rear side of the apparatus for parking stringed musical instruments with the three-legged arrangement according to the embodiments of the present disclosure;

FIGS. 3 to 5 are perspective views of the apparatus of FIG. 1 in different angles according to the embodiments of the present disclosure;

FIG. 6 is a perspective view depicting the rear side of the apparatus for parking stringed musical instruments with a four-legged arrangement according to the embodiments of the present disclosure;

FIG. 7 is an exemplary illustration of a stringed musical instrument compatible with the apparatus disclosed by the present disclosure;

FIG. 8 is an exemplary illustration of the apparatus described in FIG. 6 attached to a ukulele according to the embodiment of the present disclosure;

FIG. 9 is an exemplary illustration of the apparatus described in FIG. 1 attached to a guitar according to the embodiments of the present disclosure;

FIG. 10 is an exemplary illustration of the side view of a musical instrument parked on the apparatus described in FIG. 1 according to the embodiments of the present disclosure;

The drawings described herein are for illustration purposes only and are not intended to limit the scope of the present subject matter in any way.

### DETAILED DESCRIPTION

Embodiments described herein discloses an apparatus for parking stringed musical instrument in an upright position. The apparatus may be used as an accessory for conveniently parking instruments such as guitars and ukuleles in an upright position on the go without the requirement of any additional support. The apparatus may be portable and highly convenient to use because of its sleek design and finish. The apparatus connects to most stringed musical instruments without any hassle and even allows users to play the instrument without any hassle, while the apparatus continues to remain attached to the instrument.

The apparatus disclosed herein may be attached to a wide range of stringed musical instruments such as different types of guitar, violin, cello, ukulele, viola, sitar, veena, banjo, fiddle, mandolin, guitarron, and the like. As long as the musical instrument's body has a compatible surface on its lower end face, it may be attached to it conveniently. The apparatus is generally attached to the lower end face of the musical instrument's body. The apparatus may have a flexible body with the front side being the connecting side and the rear side acting as a supporting side. The front side of the apparatus or the connecting side attaches itself onto the compatible surface of the musical instruments when pressed onto the lower end face of the instrument as described in the figures.

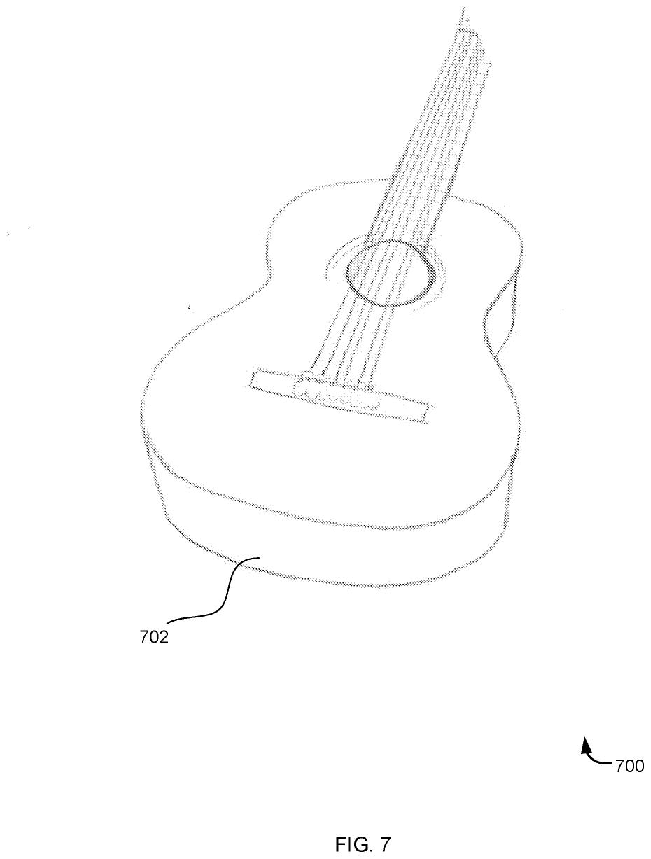

The front side of the apparatus may comprise an adhesive substance that allows the apparatus to be connected to the lower end face of musical instruments. The depiction 700 in FIG. 7 clearly describes the lower end face 702 of a stringed musical instrument. Generally, the lower end face of such instruments have a slightly curved surface. Some modified instruments may have a straight surface without any curve as well. The apparatus is compatible with any such modified instrument as long as there is enough surface area in the musical instrument to create a secure attachment with the apparatus's connecting side. The flexible nature of the apparatus allows it to adapt to the shape of most stringed musical instruments. The rear side of the apparatus may comprise either three or four legs that act as supporting members. The legs provide support for the apparatus to allow musical instruments to be parked in an upright position.

It may be noted that the terms “musical instrument”, “stringed instrument”, “stringed musical instrument”, and “instrument” may be used interchangeably throughout this document as per the context of the sentence. The terms “leg” and “foot” may be used interchangeably throughout this document. The terms “arrangement”, “assembly”, and “configuration” may be used interchangeably throughout this document. The terms used herein do not restrict the scope of the present disclosure.

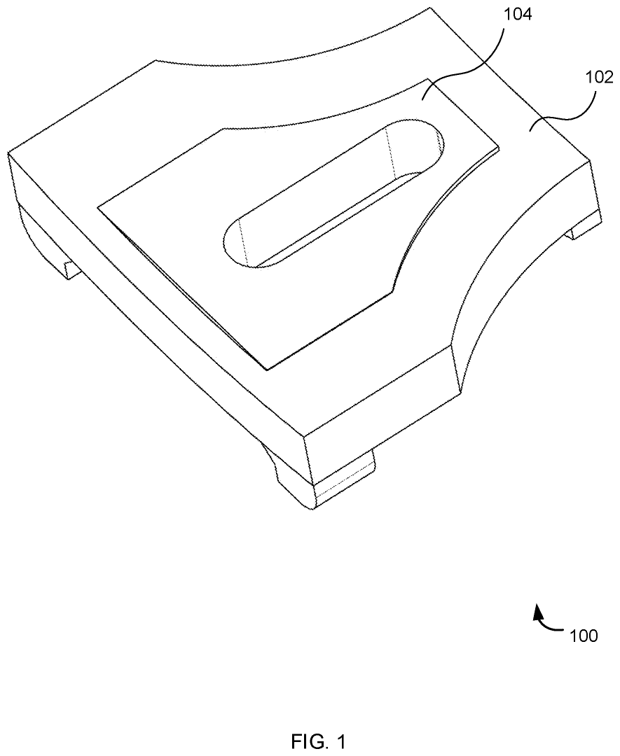

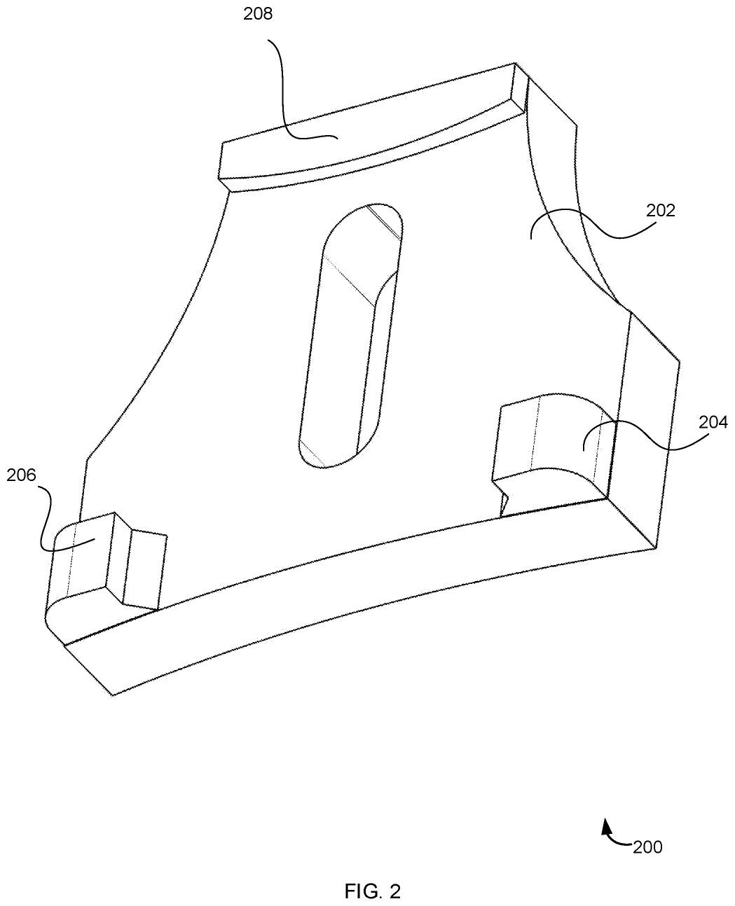

Before moving to the succeeding sections of this disclosure that describes the working of the apparatus in detail, it is pertinent to refer to the various numbering provided in the drawings. Referring to the drawings, FIG. 1 is a perspective view 100 depicting the front side of the apparatus for parking stringed musical instruments with three-legged arrangement. The front side (or the connecting side) 102 is where the adhesive 104 is provided. FIG. 2 is a perspective view 200 depicting the rear side 202 of the apparatus for parking stringed musical instruments with three-legged arrangement. The first leg 204, the second leg 206, and the third leg 208 together provide support for allowing musical instruments to be parked on the apparatus in an upright position.

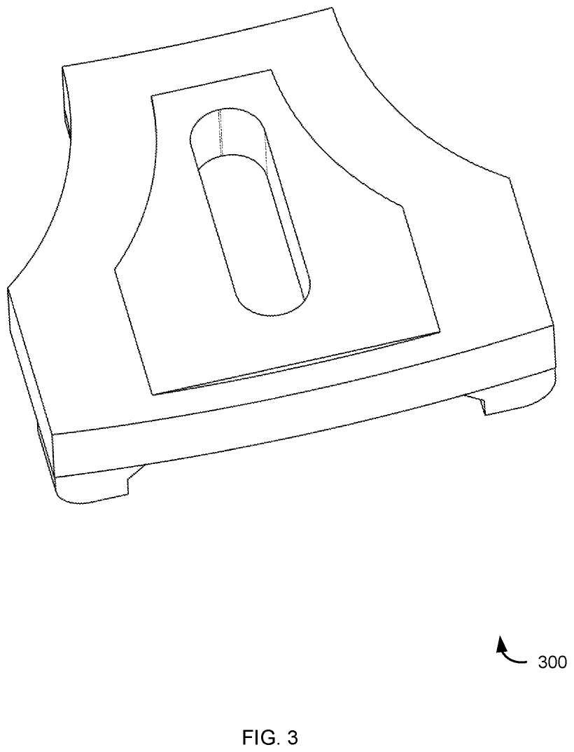

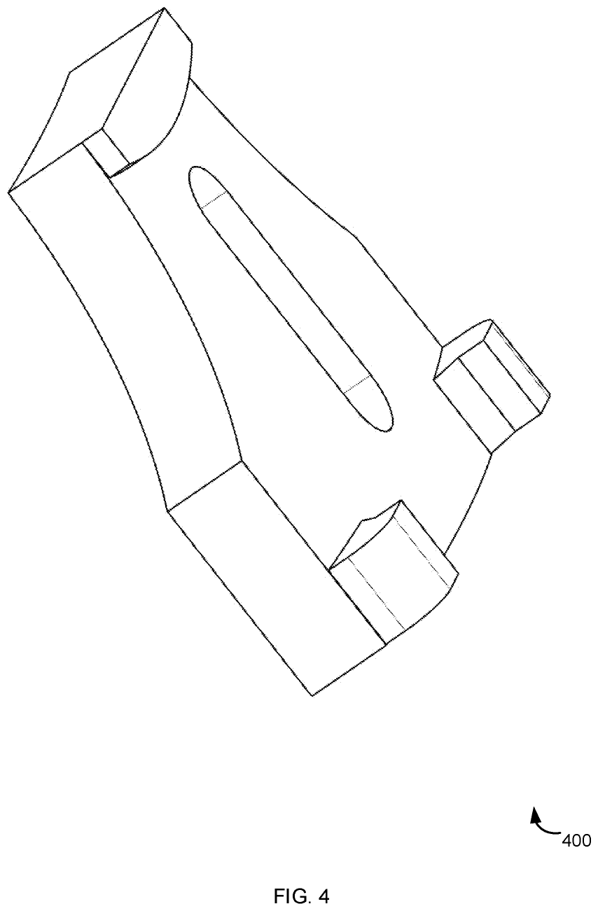

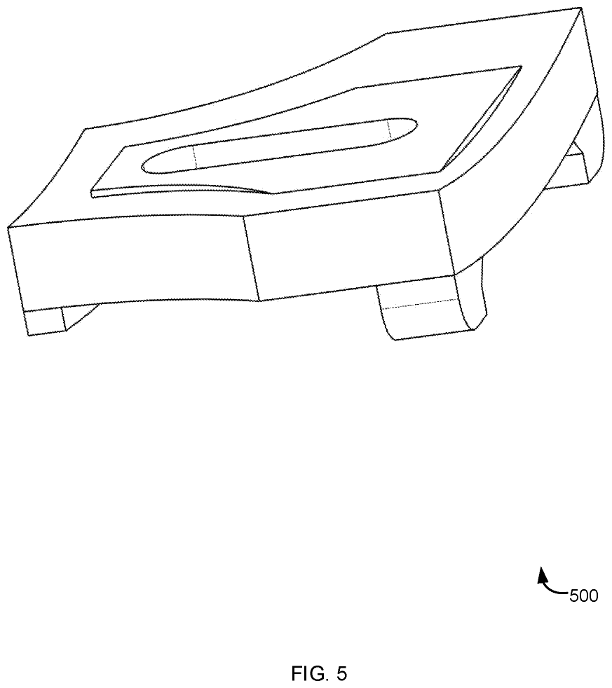

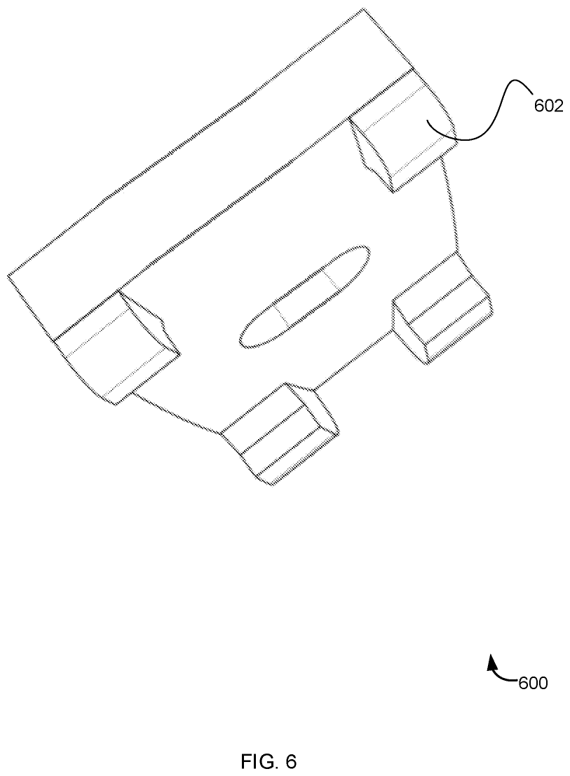

FIGS. 3 to 5 are perspective views 300, 400, and 500 of the apparatus described in FIGS. 1 and 2 in various angles. FIG. 6 is a perspective view 600 depicting the rear side of the apparatus for parking stringed musical instruments with four-legged arrangement. As illustrated in the figure, this embodiment of the present disclosure may have four legs 602 instead of three. FIG. 7 is an exemplary illustration 700 of a stringed musical instrument compatible with the apparatus disclosed by the present disclosure. The lower end face 702 of the body of the stringed instrument is where the front side 102 of the apparatus is connected.

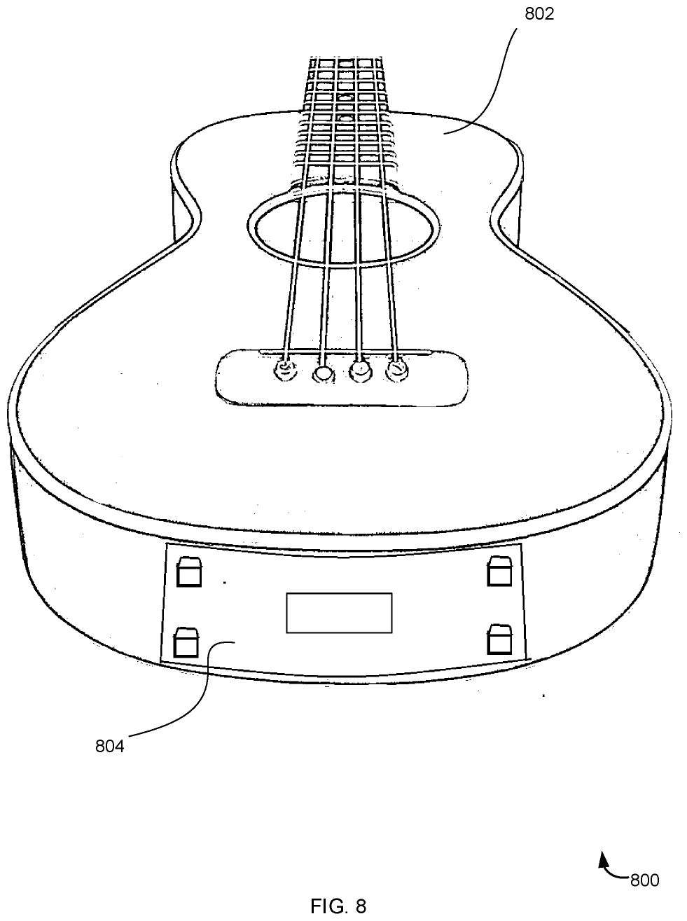

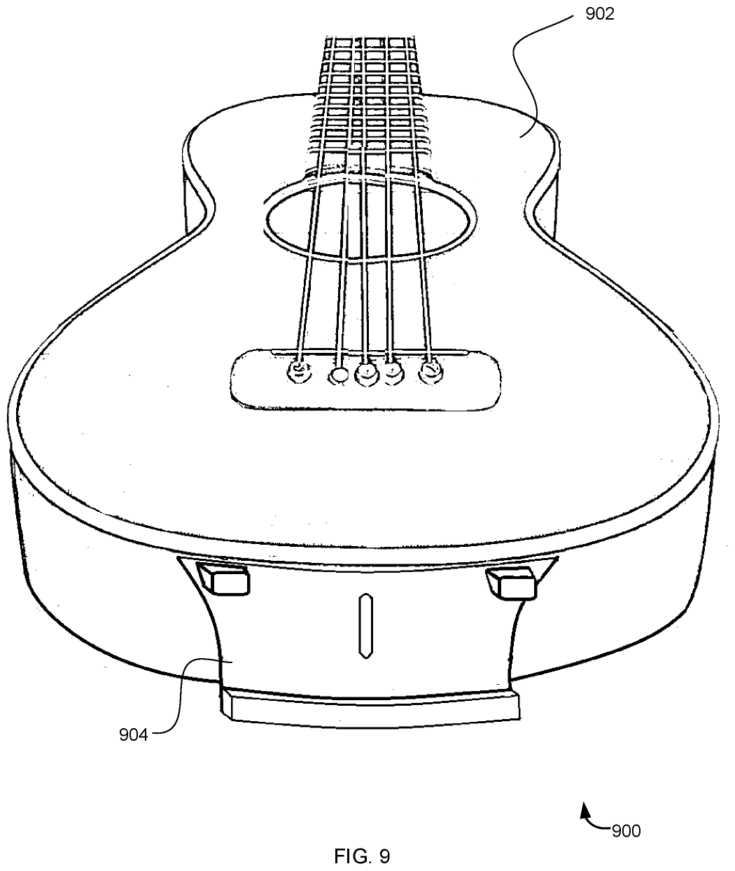

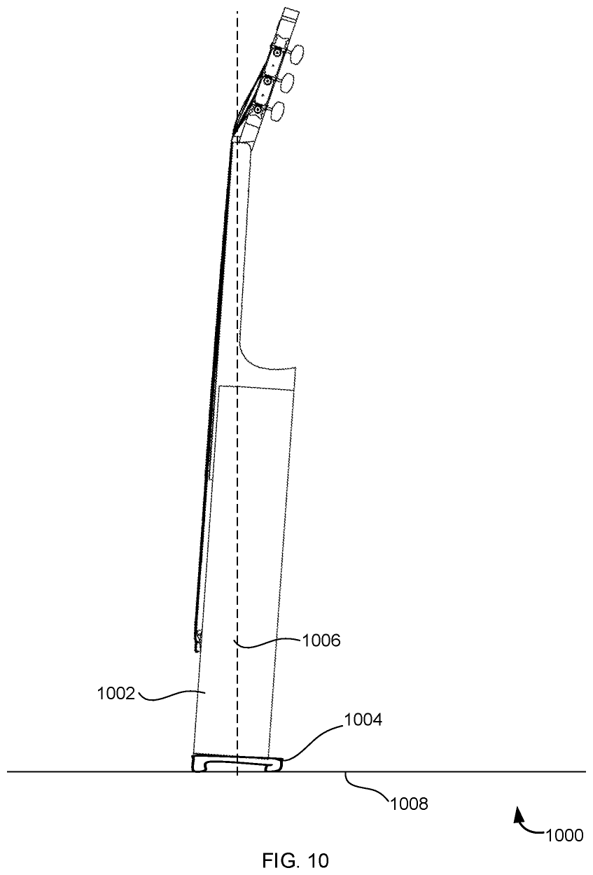

FIG. 8 is an exemplary illustration 800 of the apparatus with four-legged configuration 804 attached to a ukulele 802. FIG. 9 is an exemplary illustration 900 of the apparatus with three-legged configuration 904 attached to a guitar 902. FIG. 10 is a side view 1000 of an exemplary musical instrument 1002 parked upright on the apparatus with three-legged configuration 1004 according to the embodiments of the present disclosure. The centre of gravity 1006 of the musical instrument aligns with the central portion of the apparatus.

The body of the apparatus may be manufactured using a flexible material. The rear side of the apparatus may have three/four legs that touch the ground (or any medium onto which the instrument is parked) for allowing the apparatus and the musical instrument connected to it stay upright when parked. Since the body of most of the musical instruments and their faces have a curved surface, it becomes practically impossible for such instruments to be parked upright. Even if back support is provided by placing the instrument next to a wall, the instrument may lose support and may slide/fall down easily owing to its geometry and centre of gravity. This is the case with most of the instruments such as guitars, violins, cellos, ukuleles, and so on. These instruments do not have a flat surface that may capable of allowing them to stand independently on the ground. The apparatus disclosed herein may overcome this disadvantage and may provide a supporting base that makes it possible for the instrument to stand upright when placed/parked on a surface.

The front side 102 of the apparatus may clasp itself to the lower end face 702 of the musical instrument's body using the adhesive 104 provided on the front side of the apparatus. In one example, the adhesive 104 may include nano-tapes that use nano-suction technology to securely connect two compatible surfaces. The suction technology may provide adequate coupling force between the apparatus and the musical instrument as if it were a permanent connection. The advantage of such adhesives is that the apparatus may be easily attached and detached to/from the musical instruments without damaging the apparatus or the musical instrument. Even with repeated attachment/detachment, the body of the musical instrument may not be damaged much when compared to traditional stands and connecting techniques. Furthermore, the peculiar properties of the adhesive used herein may allow the apparatus to be washed and reused multiple times without considerably affecting its efficiency.

Furthermore, since suction technology is used, the apparatus may not leave a mark on the instrument from repetitive attachment/detachment. Alternatively, any other compatible adhesive substance may also be used to attach the apparatus onto the instrument. In one example, the adhesive may be a double-sided acrylic foam tape. The adhesive may be manufactured using a combination of polyethylene film (PE) and acryloid cement. The apparatus fixed onto the lower end face 102 of the instrument's body may be hassle-free and may not hinder users from playing the instrument. The sleek design and form factor of the apparatus makes it very handy and users may not even realize its presence once securely strapped onto the instrument. This allows users to play the instrument without having to repeatedly attach or detach the apparatus to/from the stringed musical instrument. Herein, users may pick the musical instrument that may be parked upright on the apparatus and play them on the go without going through the hassle of mechanically removing it from a conventional stand. Once the purpose is served, the user may straight away park the instrument on the ground by directly placing the apparatus and the musical instrument attached to it on any flat surface.

The rear side 202 of the apparatus may either have a three-legged configuration or a four-legged configuration. Herein, three-legged configurations may be used for supporting musical instruments of larger size owing to the scientific advantage provided by three-legged support over four-legged support. Herein, the rear side 202 of the apparatus may be provided with three legs 204, 206 and 208 arranged in a triangular pattern as described in the figure. Herein, the top and bottom edges of the body of the apparatus may be parallel in nature while the lateral edges may be curved as described in the figures. The first leg 204 and the second leg 206 may be provided on the opposing ends of the bottom edge of the flexible body of the apparatus while the third leg 208 may run along the top edge of the body. Herein, the first leg 204 and the second leg 206 may have similar dimensions while the third leg 208 may be broader/wider. The third leg 208 may extend along the entire top edge of the flexible body of the apparatus. Furthermore, the height of the third leg may be shorter compared to the first and second legs.

In this example, the area/portion of the apparatus above the bottom edge and legs may be referred to as backrest of the apparatus. The backrest may add stability to the stringed musical instrument when parked on a surface with the help of the apparatus. The backrest may cover and cusp a large area of the instrument's lower end face thereby preventing the instrument from wobbling unnecessarily. The apparatus attaches to a very wide surface area of the instrument's frame thereby providing extra support and preventing the instrument from wobbling. While the front/connecting side 102 of the apparatus clasps onto the musical instrument, the rear/supporting side 202 may diverge and extend onto three different directions to provide three distinct support points that touch the floor (or any surface onto which the apparatus is placed/parked).

The tri-support configuration may provide better support and may effectively align the centre of gravity of the apparatus as well as the instrument thereby providing a more efficient supporting mechanism. In comparison to the four-legged support, three-legged support provides a better alternative. The chances of a four-legged support to rock are comparatively higher if the surface onto which the apparatus is placed is uneven. This is not the case with three-legged support, they do not wobble or rock even if placed on uneven plains. Hence, the present apparatus provides a much better support via its three-legged design.

It may be noted that the apparatus is portable and handy, it does not affect the usability of the musical instrument thereby avoiding frequent attaching/detaching of the apparatus to/from the instrument. The apparatus may even be considered as a standard part/component of the musical instrument. It may be attached permanently onto the instrument as well. The three legs of the apparatus provide adequate support for the instrument to stand independently on most of the surfaces. This design allows the instrument to be placed conveniently on the floor or on a stage where the instrument may be used frequently. The apparatus allows instruments to be lined up on the ground for display in a shop without any hassles thereby saving space and infrastructure costs.

In one example, when a stringed musical instrument is connected to the apparatus with a three-legged configuration, the third leg 208 that extends along the top edge of the apparatus, situated on the backrest area may slightly extend outward from the instrument's frame. That is, the third leg 208 and a part of the backrest may extend outwards the geometrical surface area of the lower end face 702 of the instrument's body.

Furthermore, when the instrument is parked in an upright position in this configuration, the instruments rests in such a way that it may be slightly tilted backwards. Herein, the instrument may not rest in a vertical position with 90-degree angle. Instead, it leans slightly backwards with the weight of the instrument rightly balanced by the apparatus. Herein, the centre of gravity of the apparatus and the centre of gravity of the musical instrument aligns to provide a stable arrangement. Moreover, the extended backrest portion prevents the instrument from wobbling by providing additional stability. FIG. 10 clearly depicts this arrangement wherein the dotted line 1006 represents the centre of gravity of the musical instrument parked on the ground 1008. The apparatus that has a three-legged configuration 1004 steadily holds the guitar in an upright position as the centre of gravity of the apparatus aligns with that of the apparatus. The musical instrument 1002 slightly leans back when parked on the apparatus and rests steadily on the apparatus as described in the figure.

When the apparatus is connected to the lower end face 702 of the instrument's body, the two front legs 204 and 206 are positioned near the front side of the musical instrument's body and the third leg 208 is positioned near the backside of the musical instrument's body. The backrest area of the apparatus may have a lower height around the area near the third leg 208 compared to the area near the first leg 204 and the second leg 206. Furthermore, the third leg 208 may have a wider dimension but may have a slightly lesser height compared to the other two legs thereby allowing the instrument to tilt/rest slightly backwards when parked on a plain surface.

Apart from three-legged arrangement, the present disclosure provides for a four-legged arrangement of the apparatus as well. In this embodiment, the rear side 202 of the apparatus comprises 4 legs instead of three. Herein, the body of the apparatus may have a rectangular structure wherein the four edges of the rectangular body may host one leg each. While the front side of the apparatus has the same adhesive material that connects securely to the lower end face 702 of musical instruments, the rear side 102 may have a different arrangement of legs in this embodiment. This arrangement may be more efficient for smaller instruments that have less weight and size. Similar to the three-legged arrangement, this arrangement also allows the musical instrument to be parked upright with a slight backward tilt.

FIG. 6 is an illustration of the four-legged arrangement of the apparatus for supporting stringed instruments. Herein, all four edges of the rectangular shaped body of the apparatus are equipped with leg supports. Herein, opposing edges of the body of the apparatus are parallel to each other. The body is flexible and adapts to the curves seen on most musical instrument's body and lower end face. This arrangement may be more suitable for instruments such as ukulele that may be parked upright. The apparatus may allow parking of instruments on tabletops, showcases, and the like. Herein, the pair of legs on the front side of the apparatus may have more height that the pair of legs on the rear side of the apparatus. FIG. 8 provides an illustration 800 of the apparatus with four-legged arrangement 804 connected to a stringed instrument 802. In one example, the stringed instrument of FIG. 8 may be a ukulele. The four-legged arrangement on the rear side of the flexible body is arranged in a rectangular pattern. The varying heights of the legs in both the three-legged arrangement and the four-legged arrangement provide maximum balance/support to the stringed musical instruments that are parked on the apparatus.

The body of the apparatus may be flexible and may preferably be manufactured using materials such as silicone, rubber, soft plastic, synthetic polymers, fibre, and the like. In one example, the apparatus may be manufactured using thermoplastic polyurethane (TPU). Properties of the material that may be used in manufacturing the instant apparatus may include but not limited to high abrasion resistance, low-temperature performance, high shear strength, high elasticity, transparency, oil and grease resistance.

The flexible nature of the apparatus allows it to be adapted and used with instruments of different shapes, sizes, and form factors. Moreover, the material used in manufacturing the apparatus may be light-weight and durable. The light-weight and soft nature of the apparatus may allow users to ignore its presence for a long time thereby being considered as a permanent fixture on the apparatus in the long run.

The primary advantage of the apparatus is the convenience it may provide to artists in several real-life situations. During scenarios such as recording sessions and live performances, artists may have to frequently park and/or switch between their musical instruments while performing multiple tasks simultaneously. Moreover, multiple instruments may be used by the artist during a short span of time. It becomes very inconvenient if the instruments have to be parked on stands which may be located at a particular location at a fixed height. In most situations, an artist may simultaneously do more than one task such as writing a lyric, recording a song, singing a song, managing a recording console, and the like, while simultaneously playing the instrument. In such situations, the artist may have to park the instrument frequently for switching onto another task and vice versa. Most of the stands available in the market do not provide the convenience of readily parking the instrument onto a surface without any hassles. In most cases, the instrument may have to be clipped/fixed on the stand which may not be portable either. Furthermore, such stands act as a hindrance if placed very close to the artist's working area.

In such scenarios, the present apparatus provides a hassle-free alternative by providing a portable and readily usable solution. The present apparatus may be fixed onto the instrument and the instrument may be played with the apparatus fixed onto it. The apparatus may not cause any hindrance in playing the instrument. Furthermore, the apparatus facilitates the artist to park the instrument right away on any surface without any hassle. The instrument may sit comfortably on most of the surfaces due to the novel supporting mechanism provided by the apparatus. The instrument may be picked and played by the artist, and be parked back as many times in quick successions without any hassle due to the convenience provided by the apparatus's design and form factor.

The apparatus described herein may be manufactured in different dimensions so as to cover a wide range of stringed musical instruments. It may also be used on other types of musical instruments which does not have a flat surface to provide support. The dimensions may be varied to accommodate different types of stringed musical instruments available around the world including but not limited to guitar, ukulele, violin, viola, sitar, banjo, mandolin, sitar, veena, lute, guitarron, fiddle, and cello.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An apparatus for parking stringed musical instruments in an upright position, comprising:
a flexible body wherein the front side of the flexible body is provided with an adhesive that allows the apparatus to be removably attached to the lower end face of the stringed musical instrument; and
a combination of three or four legs provided on the rear side of the flexible body, wherein the combined support provided by the legs allow the stringed musical instrument to be parked in an upright position on the ground.

2. The apparatus of claim 1, wherein the three-legged arrangement on the rear side of the flexible body is arranged in a triangular pattern with similar sized first and second legs occupying opposing ends of the bottom edge of the flexible body while the third leg which is broader than the first and the second legs is provided on the top edge of the flexible body.

3. The apparatus of claim 2, wherein the third leg extends along the entire top edge of the flexible body.

4. The apparatus of claim 3, wherein the third leg is comparatively shorter than the first and second legs.

5. The apparatus of claim 4, wherein the top edge of the flexible body is parallel to the bottom edge and the lateral edges are curved.

6. The apparatus of claim 5, wherein the musical instrument supported by the apparatus is a guitar.

6. The apparatus of claim 1, wherein the four-legged arrangement on the rear side of the flexible body is arranged in a rectangular pattern.

7. The apparatus of claim 6, wherein the flexible body has a rectangular shape and each edge of the rectangular flexible body is provided with one leg each.

8. The apparatus of claim 7, wherein the legs provided on the top edges of the apparatus are comparatively shorter than the legs provided on the bottom edges.

9. The apparatus of claim 8, wherein the musical instrument supported by the apparatus is a ukulele.

10. The apparatus of claim 1, wherein the flexible body is made using thermoplastic polyurethane (TPU).

11. The apparatus of claim 1, wherein the front side of the flexible body comprising the adhesive is washable and reusable.

12. The apparatus of claim 1, wherein the adhesive works according to the principle of nano-suction.

13. The apparatus of claim 13, wherein the adhesive is a double-sided acrylic foam tape.

14. The apparatus of claim 14, wherein the adhesive comprises a combination of polyethylene film (PE) and acryloid cement.

15. The apparatus of claim 1, wherein the legs of the apparatus are arranged in such a way that the centre-of-gravity of the stringed musical instrument parked in upright position on the apparatus passes through the central portion of the apparatus to provide adequate stability to the stringed musical instrument.

16. The apparatus of claim 1, wherein the stringed musical instrument includes at least one of: guitar, ukulele, violin, viola, sitar, banjo, mandolin, sitar, veena, lute, guitarron, fiddle, and cello.
